(19) United States
(12) Patent Application Publication
(10) Pub. No.: US 2026/0180249 A1
(43) Pub. Date: Jun. 25, 2026

(54) ELECTRICAL CONNECTOR DISENGAGEMENT LEVER TOOL

(71) Applicant: Raytheon Company, Arlington, VA (US)

(72) Inventors: Andrew J. Bristol, Los Angeles, CA (US); Paola V. Lopez, Santa Fe Springs, CA (US); Erick Jones, Carson, CA (US); Eduardo Arana, Redondo Beach, CA (US); Sung H. Lee, Valencia, CA (US); Keith R. Burrell, Rancho Palos Verdes, CA (US)

(21) Appl. No.: 18/990,979

(22) Filed: Dec. 20, 2024

(51) Int. Cl. H01R 13/633; H01R 13/502; H01R 13/627; H01R 24/40

(52) U.S. Cl. CPC H01R 13/633; H01R 13/502; H01R 13/627; H01R 24/40

(57) ABSTRACT

A disengagement lever tool that can decouple an electronic connection can include a lever housing, a lever body translatably coupled with the lever housing, and a biasing member. The lever housing can include one or more laterally extending walls surrounding a cavity, one or more tracks formed along the laterally extending walls and an anchor with a footing. The lever body can include one or more grips positioned external to the one or more laterally extending walls. The one or more grips can receive a force. The lever body can also include a decoupling catch coupled with the lever body and positioned proximate to the anchor.

### BACKGROUND

Sub Miniature Push-on Micro (SMPM) connectors are a type of radio frequency (RF) connector designed for high-frequency applications. These connectors are known for their compact size, high performance, and ease of use in blind-mate applications. Blind-mate applications are situations where electronic connectors are mated, or connected, without visually aligning them beforehand. Blind-mate applications can include situations where the connectors are positioned in tight spaces or locations that can be difficult to access. Blind-mate RF connectors can be used without tools to assist in positioning the connection. Some configurations of blind-mate applications include configurations that can feature a smooth bore into which the mate simply slides to connect.

In some examples, an SMPM, as a connector, can be implemented on or with computer hardware. An SMPM can be implemented on a printed wire board (PWB). A PWB can include a medium used to connect, or wire, components to each other in a circuit. Electrical components can be fixed on outer layers by means of soldering, as least base portions of the electrical components. For example, a base (e.g., male or female coupling) is fixed on the PWB and an opposing connector can be coupled with the base.

### SUMMARY

A disengagement lever can be used for decoupling an electrical connector from an electrical socket, the disengagement lever can include a lever housing including. The lever housing can include one or more walls that define a cavity. Positioned at a distal portion of the lever housing can be an anchor. A lever body can be movably coupled with the lever housing. The lever body can include one or more grips that extend longitudinally away from the lever body. A decoupling catch including a recess can be coupled with a distal portion of the lever body. A biasing member can be operationally coupled with the lever housing and the lever body.

A method for disengaging an electrical connector from an electronics board can include positioning a disengagement lever proximate to the electrical connector. The electrical connector can include a connector head providing electrical communication between an electrical cable and an electrical socket. The disengagement lever can include a lever housing and a lever body. The lever body can be translatably coupled to the lever housing. The lever body can include one or more longitudinally extending grips. The method can include aligning an anchor proximate to a base of the electrical socket. The anchor can be coupled to a distal portion of the lever housing and can longitudinally extend from the lever body. The method can also include locating a decoupling catch, coupled with the lever body, against a portion of the connector head. The decoupling catch can be positioned more proximal along the disengagement lever than the anchor and can extend longitudinally from the lever body. The method can also include retaining the connector head within the decoupling catch. Another step in the method can include bracing the anchor against the base of the electrical socket proximate to the electronics board. While bracing the anchor, a force can be applied to the one or more longitudinally extending grips. The method can also include translating the decoupling catch away from the anchor. Translating the decoupling catch can release the connector head from the electrical socket when translating the decoupling catch away from the anchor.

### BRIEF DESCRIPTION OF THE DRAWINGS

FIGS. 1A and 1B illustrate perspective views of a disengagement lever according to at least one example of the present disclosure.

FIG. 2 illustrates an example of a cross section of a disengagement lever according at least one example of the present disclosure.

FIG. 3 illustrates an electronics board including one or more electrical connectors according to at least one example of the present disclosure.

FIG. 4 illustrates an electrical connector according to at least one example of the present disclosure.

FIG. 5A illustrates a disengagement lever proximate to an electrical connector according to at least one example of the present disclosure.

FIG. 5B illustrates a disengagement lever aligned in an initial tool arrangementwith an electrical connector according to at least one example of the present disclosure.

FIG. 5C illustrates a disengagement lever aligned with an electrical connector according to at least one example of the present disclosure.

### DETAILED DESCRIPTION

The use of Sub Miniature Push-on Micro (SMPM) connectors with surface mount technology (SMT) on circuit card assemblies (CCAs) can have a simplified fabrication process compared to traditional through-hole connectors. SMPM can also provide a space-saving design and can be implemented in systems that can have size-constrained space. Their small form factor allows for high-density installations on circuit card assemblies (CCAs).

SMPM connectors can be designed to withstand harsh environmental conditions, including extreme temperatures, vibrations, and mechanical shocks. SMPM connectors can be constructed from durable materials such as stainless steel, beryllium copper, and high-performance plastics to ensure long-term reliability. SMPM connectors can be used in various industries, including aerospace, defense, telecommunications, and space electronics, due to their ability to provide reliable and efficient connections in demanding environments.

SMPM connectors can utilize a push-on mechanism for mating and de-mating. This mechanism can allow for quick and easy connections without the need for additional tools or fasteners. The push-on design also can assist in reducing damage to the connectors and the associated circuitry. One feature of SMPM connectors is their blind-mate capability. Blind-mate systems can include connectors that can be mated and de-mated without precise alignment. Connectors that are used in blind-mate systems can be beneficial in applications where visual confirmation is reduced or not possible.

SMPM connectors can be a type of RF connector designed to include a compact size without reducing performance. SMPM connectors, as RF connectors, used in blind-mate systems can be significantly smaller than traditional RF connectors. For example, SMPM connectors can be beneficial for applications where space is limited. In some examples, SMPM connectors offer increased RF performance for high-frequency applications compared to other connectors in blind-mate systems.

In some situations, a socket, or base portion of an electrical connector is coupled with an electronics board. The electrical connector can be soldered to the surface of an electronics board, such as a PWB. Soldering, or otherwise connecting, the socket to the electronics board can present challenges when decoupling a connector head from the socket. For example, disengagement of SMPM connectors can apply excessive force to the solder joints, leading to stress and potential damage. The disengagement process can result in misalignment of the connectors. Misalignment can compromise RF performance and potentially cause damage to the connectors and the PWB or CCA.

In another example, circuit traces on the CCA board are delicate and located underneath the electrical connector. The circuit traces can be at risk of being torn off during a disengagement process. If the traces are torn off, or become misaligned, during the disengagement process, the traces can become irreparable and can render the entire PWB or CCA unusable.

To address the above challenges, a specialized tool for the controlled and repeatable de-mating of SMPM connectors is described below. Such a tool can assist in maintaining a connection between a socket, or the part of an electrical connector coupled with an electronics board, during a disengagement process.

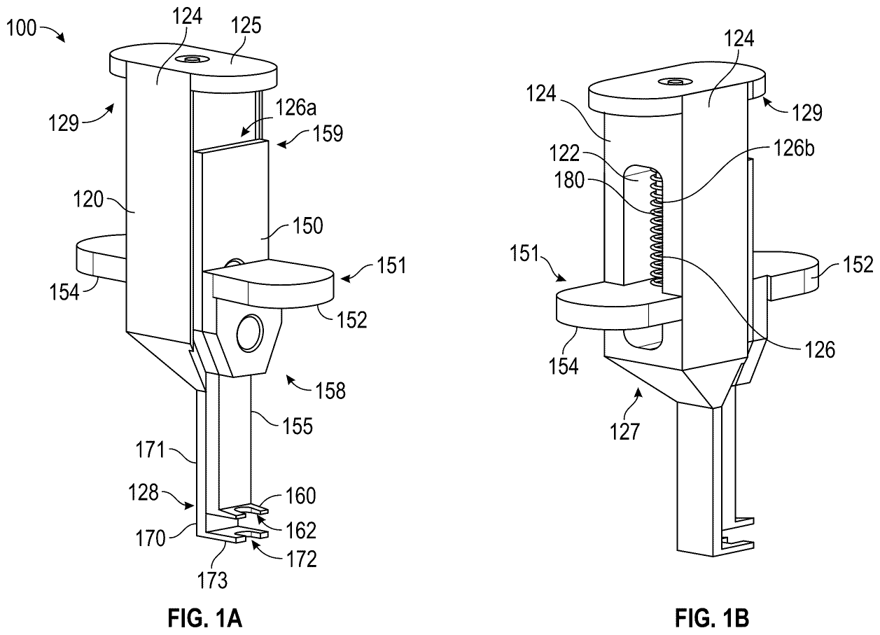

Illustrated in FIGS. 1A and 1B is an example of a tool for controlled de-mating of an SMPM connector. For example, the tool illustrated in FIGS. 1A and 1B includes a disengagement lever 100. FIG. 1A is an example of a view of the disengagement lever 100 from a first side and FIG. 1B is an example of a view of the disengagement lever 100 from a second, opposing side. The disengagement lever 100 can be a tool that can lift or move portions of an electrical connector to decouple or disengage associated portions. In an example, the disengagement lever 100 can extend from a proximal portion 129 to a distal portion 128. The proximal portion 129 can be a portion of the disengagement lever 100 that is oriented more upward than the distal portion 128 when the disengagement lever 100 is in use. The proximal portion 129 can be a portion of the disengagement lever 100 that is more distant from an electrical connector than the distal portion 128, when the disengagement lever 100 is in use. In an example, the proximal portion 129 of the lever housing 120 can include a force application surface 125. The force application surface 125 can receive a force applied with a hand or digit of a user.

The disengagement lever 100 can include a lever housing 120. The lever housing 120 can be the body of the disengagement lever 100 to which motive components of the disengagement lever 100 can be coupled (e.g., attached, connected, joined, or the like). The lever housing 120 can be formed from one or more walls 124. The one or more walls 124 can be a continuous wall, such as a cylindrical form. In another example, the one or more walls 124 can include more than one wall with each wall connected to form a rectangular prism. Other three-dimensional polygonal profiles can be formed with the one or more walls 124 according to the purpose.

The one or more walls 124 can define a cavity 122. The cavity 122 can extend through the lever housing 120. For example, the cavity 122 can extend from an inner surface of one of the one or more walls 124 to an opposing inner surface of another of the one or more walls 124. In another example, the cavity 122 can extend partially within the lever housing 120. For instance, the cavity 122 can include a recess formed between at least two of the one or more walls 124.

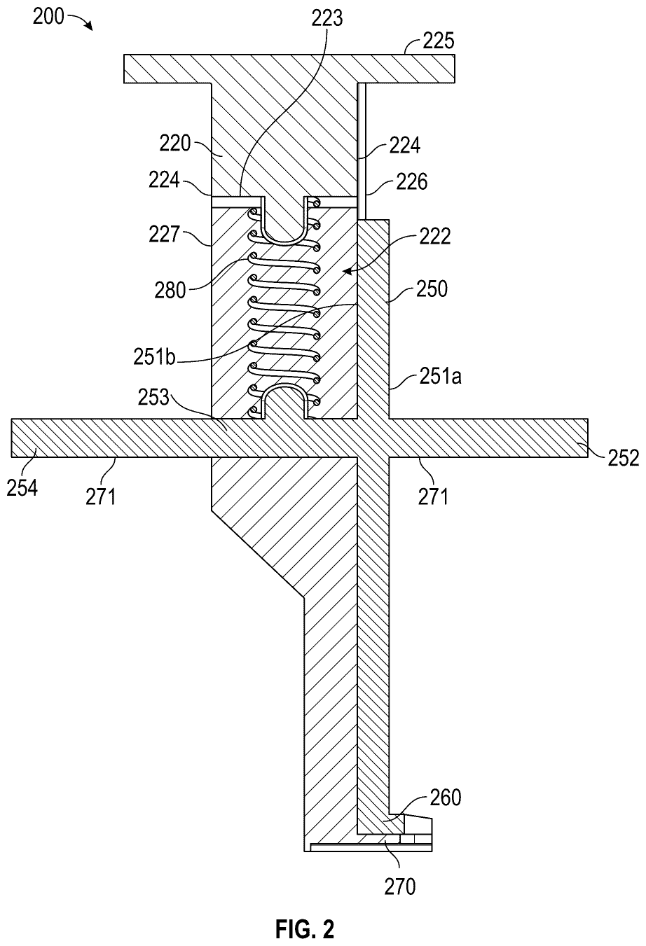

Optionally, positioned relative to the cavity 122 or within the cavity 122 can be a biasing member 180. The biasing member 180 can be positioned to extend in the longitudinal direction within the cavity 122. As discussed further in FIG. 2, the biasing member 180 can be movably coupled with both the lever housing 120 and the lever body 150. The biasing member 180 can be movably coupled to control (e.g., regulate, limit, restrict or the like) the movement of a lever body 150, discussed below, relative to the lever housing 120.

The lever housing 120 can include one or more tracks 126 formed along at least one wall of the one or more walls 124. The one or more tracks 126 can include a path formed on or within at least one of the one or more walls 124. For example, the one or more tracks 126 can be a recess formed within at least one wall of the one or more walls 124. The one or more tracks 126 can be recessed partially through at least one of the one or more walls 124. In another example, the one or more tracks 126 can be recessed within at least one of the one or more walls 124 to expose at least part of the cavity 122. The one or more tracks 126 can extend from proximate to the proximal portion 129 to proximate to a distal housing portion 127. The one or more tracks 126 can include a first track 126a formed along at least one wall of the one or more walls 124 and a second track 126b formed along at least an opposing wall of the one or more walls 124.

An anchor 170 can be coupled with the distal housing portion 127 of the lever housing 120. For example, the anchor 170 can extend as a leg 171 from the distal housing portion 127. The anchor 170 can extend from the distal housing portion 127 toward the distal portion 128 of the lever housing 120. The anchor 170 can be molded as a singular unit with the one or more walls 124. In another example, the anchor 170 can be welded, adhered, or otherwise joined with the one or more walls 124.

The anchor 170 can include a foot 173 positioned at a distal portion 128 of the anchor 170. The foot 173 can extend transversely away from the leg 171. In an example, the foot 173 can extend from the leg 171 to rest firmly on a surface. The foot 173 can be coupled with the leg 171 with an adhesive, weld, fastener or the like. In another example, the foot 173 is molded with the leg 171.

The foot 173 can include an anchor recess 172. The anchor recess 172 can be a concave form within the foot 173. For example, the anchor recess 172 extends partially within the foot 173. The anchor recess 172 can have an open profile to fit around, or receive, at least a portion of an electrical connector. For example, the anchor recess 172 can have a “U” form with a radius corresponding to at least a portion of an electrical connector.

A lever body 150 can be coupled with the lever housing 120. The lever body 150 can extend from a body proximal portion 159 to a body distal portion 158. The body proximal portion 159 can be coupled with the lever housing 120 proximate to the proximal portion 129 of the lever housing 120. The body distal portion 158 can be coupled with the lever housing 120 proximate to the distal housing portion 127 of the lever housing 120.

In an example, the lever body 150 is movably coupled along the lever housing 120. In another example, the lever body 150 is translatably, movably coupled with the lever housing 120. For instance, the lever body 150 can be translated in a distal direction or a proximal direction. The lever body 150 can be coupled in a parallel configuration related to the form of the lever housing 120.

The lever body 150 can include an extension 155. The extension 155 can be coupled with the body distal portion 158 of the lever body 150. The extension 155 can be coupled with the body distal portion 158 with an adhesive, weld, or fastener or the like. In another example, the extension 155 can be formed as one component with the other portions of the lever body 150. The extension 155 can be coupled with the lever body 150 to be movably coupled with the lever housing 120.

Located proximate to a distal portion of the extension 155 can be a decoupling catch 160. The decoupling catch 160 can extend or protrude from a distal portion of the extension 155. In an example, the decoupling catch 160 extends in a direction transverse to the extension 155. Optionally, the decoupling catch 160 extends at an angle away from the extension 155. The decoupling catch 160 can be coupled with the extension 155 with an adhesive, weld, fastener or the like. The decoupling catch 160 can be formed as one component with the extension 155.

The decoupling catch 160 can include a catch recess 162. The catch recess 162 can extend within the decoupling catch 160 in a similar direction to the direction of the decoupling catch 160 extends away from the extension 155. The catch recess 162 can include an opening configured to be positioned around an electrical connection. The catch recess 162 can be a “U” shaped recess formed in the catch recess 162. In an example, the catch recess 162 can be formed with a radius that corresponds to an electrical connector. The decoupling catch 160 can be formed so the catch recess 162 is aligned with the anchor recess 172. For instance, the catch recess 162 can be positioned and aligned in a more proximal direction than the anchor recess 172.

One or more grips 151 can be coupled with the lever body 150. The one or more grips 151 can be coupled to extend longitudinally away from the lever body 150. For instance, the one or more grips 151 can extend transversely from the lever body 150. The one or more grips 151 can be positioned proximate to a mid-section of the lever body 150. In another example, the one or more grips 151 can be positioned proximate to the body proximal portion 159 or the body distal portion 158.

The one or more grips 151 can include at least a first grip 152 and a second grip 154. The first grip 152 can be positioned to extend from the lever body 150. The second grip 154 can extend on an opposed side of the lever body 150 and also can extend from an opposed side of the lever housing 120 from the first grip 152. For instance, as discussed further related to FIG. 2, the second grip 154 and the first grip 152 can be coupled together to jointly move or translate when subjected to an externally applied force.

Illustrated in FIG. 2 is an example of a cross section of a disengagement lever 200. The disengagement lever 200 illustrated in FIG. 2 includes a cross-sectional view of a lever body 250 relative to a lever housing 220. The lever body 250 can be positioned to be flush, or positioned to be in contact with at least one wall of one or more walls 224 that form the lever housing 220. The lever body 250 can be movably coupled with the lever housing 220.

As illustrated in FIG. 2, the lever body 250 can include a first grip 252 extending longitudinally away from the lever body 250. The lever body 250 can also include a second grip 254 that can extend longitudinally away from the lever body 250 in a direction opposing the first grip 252. The lever body 250 can also include a force application surface 225 positioned at a proximal portion of the lever housing 220. The force application surface 225 can be a planar surface that can be sized to receive or support a part of a user's hand such as a finger or thumb.

In an example, the first grip 252 and the second grip 254 extend along a similar longitudinal plane. The first grip 252 can extend longitudinally in a first direction away from a first side 251a of the lever body 250. The second grip 254 can extend longitudinally in a second direction away from a second side 251b. The first grip 252 can extend transversely from the first side 251a. The second grip 254 can extend transversely from the second side 251b. In an example, the second grip 254 can include a bridge 253 that can be a portion of the second grip 254 that extends through the lever housing 220.

The first grip 252 and the second grip 254 can be coupled with the lever body 250. For example, the first grip 252 can be adhered, welded, fastened or otherwise coupled with the first side 251a of the lever body 250. The second grip 254 can be adhered, welded, fastened or otherwise coupled with the second side 251b of the lever body 250. In another example, the first grip 252 is formed as a unitary component with the lever body 250. Optionally, the second grip 254 can be formed as a unitary component with the lever body 250. In yet another example, both of the first grip 252 and the second grip 254 are formed as a unitary component with the lever body 250, with each of the first grip 252 and the second grip 254 on opposing sides of the lever body 250. The bridge 253 can be a portion of the second grip 254 that is coupled with the lever body 250 and extends away from the lever body 250.

The first grip 252 and the second grip 254 each can include a distally facing planar surface 271. The distally facing planar surface 271 can be formed as an engaging surface. The distally facing planar surface 271 can be a surface that can receive a force, such as from a user's hand or fingers. In an example, the distally facing planar surface 271 of the second grip 254 can be a portion of the second grip 254 that extends from the bridge 253 and outside of the lever housing 220.

The second grip 254, or the bridge 253, can extend from the second side 251b of the lever body 250 and through a cavity 222 of the lever housing 220. The cavity 222 can be defined by a space extending between the one or more walls 224. The lever body 250 can be positioned relative to one wall of the one or more walls 224 with the second grip 254 extending through or into a track 226 formed in the one wall of the one or more walls 224. The track 226 can extend laterally along at least one wall of the one or more walls 224. For instance, the track 226 can provide an opening into the cavity 222. An opposing track 227 can be formed in a second, opposing wall of the lever housing 220. The second grip 254 extend through the cavity 222 and through the opposing track 227.

Positioned relative the lever housing 220 can be a biasing member 280. For example, the biasing member 280 can be positioned within the cavity 222. The biasing member 280 can extend laterally within the cavity 222. For instance, the biasing member 280 can be supported with a distal portion of the cavity 222, such as a distal wall 223. An opposing lateral portion of the biasing member 280 can be supported by the bridge 253. For example, the bridge 253 can engaged with the biasing member 280. The biasing member 280 can be coupled with the bridge 253 to control (e.g., regulate, limit, restrict or the like) movement of the lever body 250 when the lever body 250 moves or translates relative to the lever housing 220. The biasing member 280 can be movably coupled with the lever housing 220 and the lever body 250.

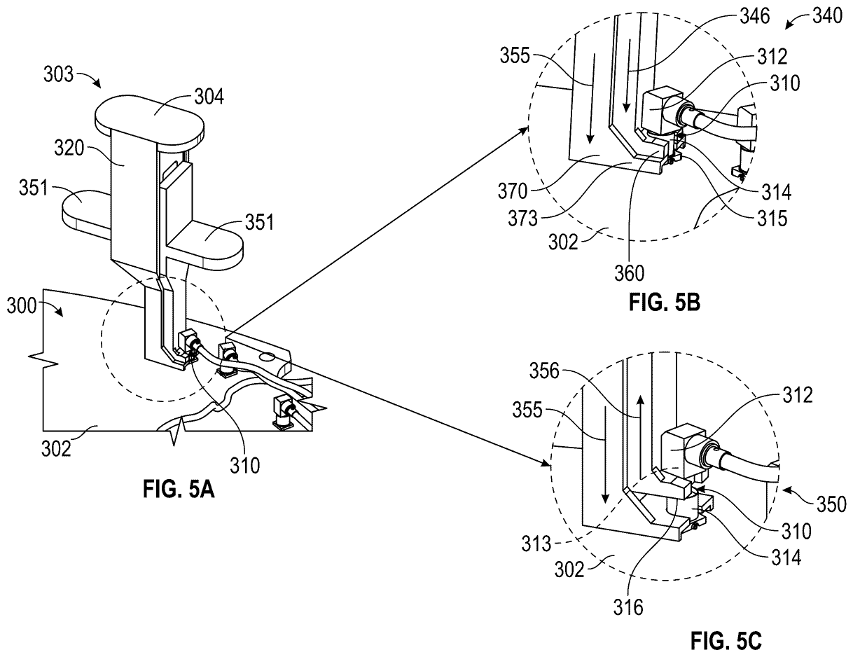

In an example, the first grip 252 and the second grip 254 can be moved or translated relative to the lever housing 220. The first grip 252 and the second grip 254 can be moved or translated with an application of force against the distally facing planar surface 271. Moving the first grip 252 and the second grip 254 can translate a decoupling catch 260 in a proximal direction relative to an anchor 270, similar to decoupling catch 160 and the anchor 170 discussed related to FIGS. 1A and 1B. The anchor 270 can coupled with a distal portion of the lever housing 220 and can provide a support or brace when the disengagement lever 200 is in use. For instance, and as discussed further related to FIGS. 5A, 5B and 5C, the anchor 270 can statically brace the disengagement lever 200 when the first grip 252 and the second grip 254 are moved in a proximal direction and thereby moving the decoupling catch 260.

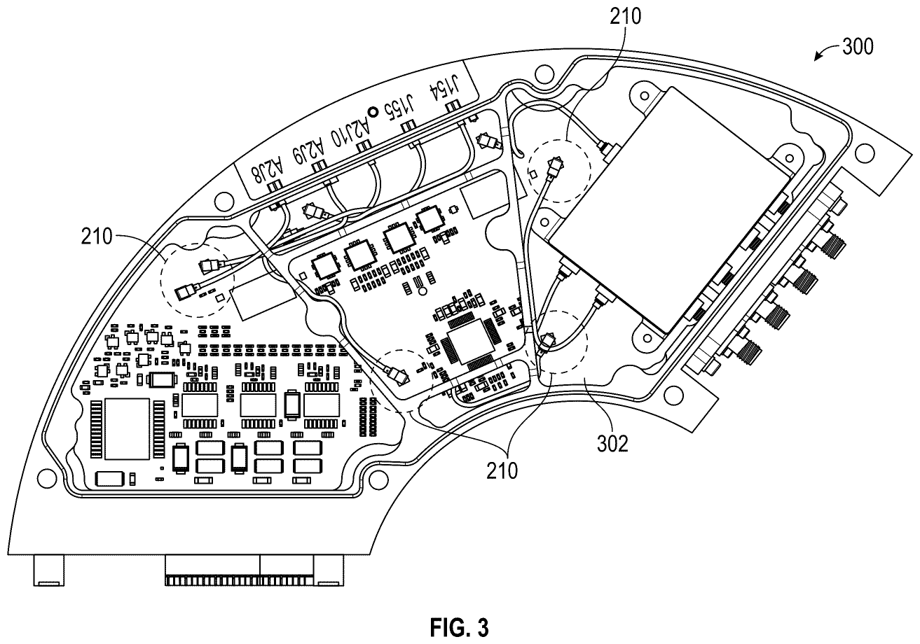

Illustrated in FIG. 3 is an example of an electronics board 300. The electronics board 300 can be a printed wire board (PWB) or a printed circuit board (PCB). The electronics board 300 can include a system that interconnects electrical components. While illustrated in FIG. 3 is a PWB, other panels, systems, assemblies, cabinets, chassis or the like, are referred to herein as the electronics board 300. For example, the electronics board 300 can include a substrate 302 that can support one or more electrical connectors 210. In an example, one or more electrical connectors 210 can be positioned on one or more locations of the substrate 302.

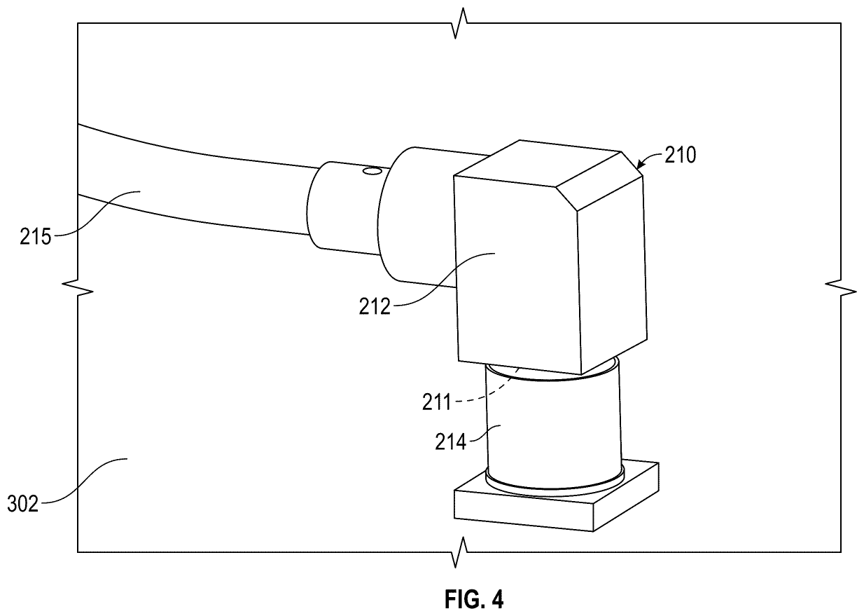

The one or more electrical connectors 210, as illustrated in FIG. 4 can be a radio frequency (RF) connector. The one or more electrical connectors 210 illustrated in FIG. 4 can be the electrical connection one or more electrical connectors 210 electrically connected to the electronics board 300 in FIG. 3. For example, the one or more electrical connectors 210 can include a connector head 212. The connector head 212 can be coupled at one portion with an electronic cable 215 and can include a connection element 211 (e.g., male or female connector) positioned at a second portion of the connector head 212. The connection element 211 can electronically engage with an electrical socket 214. The electrical socket 214 can be coupled with the substrate 302. In an example, the electrical socket 214 is soldered, brazed, welded or adhered to the substrate 302.

Optionally, the one or more electrical connectors 210 can be a Sub Miniature Push-on Micro (SMPM) connector. The SMPM can be an RF connector that can electrically connect electrical wires or traces in the electronics board 300 with external systems. The one or more electrical connectors 210, as a SMPM can include the connector head 212 detachably coupled with the electrical socket 214.

Illustrated in FIGS. 5A, 5B and 5C are examples of a method for disengaging connection components of an electronics connector 310. The electronics connector 310 can include a connector head 312 coupled with an electrical socket 314. The electrical socket 314 can be coupled with the substrate 302, as discussed related to FIG. 3 or 4. The electrical socket 314 can be coupled (e.g., welded, adhered, bonded, joined or the like) to the substrate 302. In an example, improper disengagement of the connector head 312 from the electrical socket 314 can result in the substrate 302 or the electrical connections within the substrate 302 being damaged or destroyed. A disengagement lever 303, similar to the disengagement lever 100 or 200 discussed related to FIG. 1A, 1B or 2, can be used to release the connector head 312 from the electrical socket 314 with minimal, if any, damage to the substrate 302 or the electronics connector 310.

In an example of disengaging the electronics connector 310 the disengagement lever 303 can be positioned proximate to the electronics connector 310. For example, the disengagement lever 303 includes a lever housing 320 and a lever body 350. The lever housing 320 can include an anchor 370 proximate to a distal portion of the lever housing 320, as discussed related to FIGS. 1A, 1B, or 2. The lever body 350 can be translatably coupled with the lever housing 320. The lever body 350 can include one or more longitudinally extending grips 351.

In an example, positioning the disengagement lever 303 proximate to the electronics connector 310 can include aligning the anchor 370 proximate to a base 315 of the electrical socket 314. The anchor 370 can be coupled with a distal portion of the lever housing 320. In an example, the anchor 370 can include a foot 373 that longitudinally extends from a distal portion of the lever body 350, as discussed related to FIGS. 1A and 1B. The anchor 370, including the longitudinally extending foot 373, can be positioned against the substrate 302 or against a base 315 of the electrical socket 314.

The disengagement lever 303 can be positioned in a relaxed configuration 340 relative to the electronics connector 310. For example, the biasing member 180, 280 discussed related to FIGS. 1A, 1B and 2, can be an extended and relaxed arrangement within the lever housing 320. The relaxed configuration 340 can be an initial arrangement when the disengagement lever 303 is positioned relative to the electronics connector 310 before connector head 312 is disengaged from the electrical socket 314. For example, the decoupling catch 360 can be positioned in a compliant position 346 with the decoupling catch 360 positioned proximate (e.g., in contact, slightly removed) to the anchor 370 or the foot 373. In the compliant position 346 the biasing member maintains the position of the 360 relative to the anchor 370 or the foot 373.

When initiating the process for disengaging the connector head 312 from the electrical socket 314, the disengagement lever 303 can transition from the relaxed configuration 340 to a releasing configuration. For instance, the anchor 370 can be braced with an application of a bracing force 355 applied to the disengagement lever 303. The bracing force 355 can be applied to a bracing surface 304 at a proximal portion of the lever housing 320. The bracing force 355 can assist in maintaining a static position of the anchor 370 against the electronics board 300 (as illustrated in FIG. 3).

A decoupling catch 360, as discussed related to FIGS. 1A and 1B, positioned at a distal portion of the lever body 350 can be located against a portion of the connector head 312. The decoupling catch 360 can be positioned more proximal along the lever body 350 than the anchor 370, relative to the lever housing 320. The decoupling catch 360 can longitudinally extend from the lever body 350.

The connector head 312 can be retained within the decoupling catch 360. For example, the decoupling catch 360 can be positioned against or on a surface of the connector head 312, such as an under-surface 313. The under-surface 313 can be the surface of the connector head 312 that faces the electrical socket 314. In an instance, the decoupling catch 360 can be positioned proximate to the under-surface 313 and proximate to an upper surface 316 of the electrical socket 314.

When the decoupling catch 360 is positioned relative to the connector head 312, and while bracing the anchor 370 against the base 315 or the substrate 302, a releasing force 356 can be applied to one or more of the longitudinally extending grips 351, as discussed related to FIGS. 1A, 1B, or 2. The releasing force 356 can include translating the longitudinally extending grips 351 in a proximal direction. Optionally the longitudinally extending grips 351 includes a first grip and a second grip, as discussed related to FIG. 1A, 1B or 2. A first grip and a second grip of the longitudinally extending grips 351 can assist in applying an consistent or even force to both sides of the disengagement lever 303 when the releasing force 356 is applied to the connector head 312. For example, a user can position fingers against a distally facing surface, as discussed related to FIG. 2. The user can apply a force in the proximal direction against the distally facing surface. The decoupling catch 360 can be translated in the proximal direction in response to the releasing force 356.

In an example, when the releasing force 356 is applied to the longitudinally extending grips 351, a biasing member, as discussed related to FIG. 2, can control (e.g., regulate, restrict, or the like) the movement of the lever body 350 relative to the lever housing 320. For instance, the biasing member can compress or receive a force that can assist in maintaining a constant or even releasing force 356 in a lateral direction. In another instance, the biasing member can assist with reducing an over-application of the releasing force 356 in the proximal direction.

When the decoupling catch 360 is translated in the proximal direction, the connector head 312 can be released from the electrical socket 314. In an example, applying the bracing force 355 while applying the releasing force 356 can retain the electrical socket 314 in position relative to the substrate 302 while removing the connector head 312 from the electrical socket 314.

### Aspects

Aspect 1 can include subject matter such as a disengagement lever for decoupling an electrical connector from an electrical socket, the disengagement lever comprising: a lever housing including: one or more walls, the one or more walls defining a cavity; and an anchor coupled with a distal portion of the lever housing; a lever body movably coupled with the lever housing, the lever body including: one or more grips extending longitudinally away from the lever body; and a decoupling catch coupled with a distal portion of the lever body, the decoupling catch including a recess; and a biasing member operationally coupled with the lever housing and the lever body.
Aspect 2 can include, or can optionally be combined with the subject matter of Aspect 1, to optionally include the one or more grips include a first grip positioned on a first side of the lever housing and a second grip positioned on an opposite side of the lever housing.
Aspect 3 can include, or can optionally be combined with the subject matter of one or any combination of Aspects 1 or 2 to optionally include the one or more grips includes a first grip and a second grip; wherein the lever body includes a bridge coupling the first grip and the second grip together, the bridge extending through the lever housing; wherein the bridge is configured to engage with the biasing member when a force is applied to the first grip or the second grip.
Aspect 4 can include, or can optionally be combined with the subject matter of one or any combination of Aspects 1 to 3 to optionally include the lever housing includes a track formed within at least one wall of the one or more walls.
Aspect 5 can include, or can optionally be combined with the subject matter of one or any combination of Aspects 1 to 4 to optionally include the one or more walls includes a first wall and a second wall opposing the first wall, each of the first wall and the second wall includes a laterally extending track; wherein the lever body includes a bridge coupled with the one or more grips, the bridge extending through the cavity and an end portion of the bridge extends into the laterally extending track of the first wall and the second wall.
Aspect 6 can include, or can optionally be combined with the subject matter of one or any combination of Aspects 1 to 5 to optionally include the biasing member is configured to control movement of the lever body.
Aspect 7 can include, or can optionally be combined with the subject matter of one or any combination of Aspects 1 to 6 to optionally include the anchor includes a footing extending longitudinally away from the lever body the and a recess formed within the footing, the recess having an opening configured to be positioned around an electrical connector.
Aspect 8 can include, or can optionally be combined with the subject matter of one or any combination of Aspects 1 to 7 to optionally include the lever housing includes a force application surface coupled to a proximal portion of the lever housing.
Aspect 9 can include subject matter such as a system a disengagement lever to decouple an electronic connection, the disengagement lever comprising: a lever housing including: one or more laterally extending walls surrounding a cavity; one or more tracks formed within the laterally extending walls; and an anchor coupled with a distal portion of the lever housing, the anchor including a footing; a lever body translatably coupled with the lever housing, the lever body including: one or more grips positioned external to the one or more laterally extending walls; wherein the one or more grips are configured to receive a force; and a decoupling catch coupled with the lever body and positioned proximate to the anchor; and a biasing member retained within the cavity, the biasing member operationally coupled with the lever body.
Aspect 10 can include, or can optionally be combined with the subject matter of Aspect 9, to optionally include the decoupling catch is configured to move reciprocally with the one or more grips.
Aspect 11 can include, or can optionally be combined with the subject matter of one or any combination of Aspects 9 or 10 to optionally include the one or more grips includes a first grip and a second grip, the lever body including a bridge coupling the first grip and the second grip; wherein the bridge is translatably received within the one or more tracks.
Aspect 12 can include, or can optionally be combined with the subject matter of one or any combination of Aspects 9 to 11 to optionally include a proximal portion of the biasing member is coupled with an inner surface of the cavity and a distal portion of the biasing member is coupled with the bridge.
Aspect 13 can include, or can optionally be combined with the subject matter of one or any combination of Aspects 9 to 12 to optionally include each of one or more grips are positioned transversely with respect to the lever housing.
Aspect 14 can include, or can optionally be combined with the subject matter of one or any combination of Aspects 9 to 13 to optionally include the decoupling catch includes a recess configured to receive a portion of an electrical connector.
Aspect 15 can include, or can optionally be combined with the subject matter of one or any combination of Aspects 9 to 14 to optionally include a relaxed configuration and an engaged configuration; wherein in the relaxed configuration, the biasing member statically holds the decoupling catch proximate to the anchor and in the engaged configuration the biasing member is compressed and the decoupling catch is configured to be translated away from the anchor.
Aspect 16 can include, or can optionally be combined with the subject matter of one or any combination of Aspects 9 to 15 to optionally include the lever is translatably coupled with an outer surface of the lever housing.
Aspect 17 can include subject matter such as a method for disengaging an electrical connector from an electronics board, the method comprising: positioning a disengagement lever proximate to the electrical connector; wherein the electrical connector includes a connector head providing electrical communication between an electrical cable and an electrical socket; wherein the disengagement lever includes a lever housing and a lever body translatably coupled to the lever housing, the lever body including one or more longitudinally extending grips; aligning an anchor coupled to a distal portion of the lever housing proximate to a base of the electrical socket; wherein the anchor longitudinally extends from the lever body; locating a decoupling catch coupled with the lever body against a portion of the connector head; wherein the decoupling catch is positioned more proximal along the disengagement lever than the anchor, the decoupling catch longitudinally extending from the lever body; retaining the connector head within the decoupling catch; bracing the anchor against the base of the electrical socket proximate to the electronics board; while bracing the anchor, applying a force to the one or more longitudinally extending grips and translating the decoupling catch away from the anchor; and releasing the connector head from the electrical socket when translating the decoupling catch away from the anchor.
Aspect 18 can include, or can optionally be combined with the subject matter of Aspect 17, to optionally include applying a force includes applying a releasing force to one or more grips extending from the disengagement lever to activate translating the decoupling catch includes.
Aspect 19 can include, or can optionally be combined with the subject matter of one or any combination of Aspects 17 or 18 to optionally include applying a bracing force to the disengagement lever to maintain a static position of the anchor against the electronics board, the bracing force opposite to the releasing force applied to the one or more grips.
Aspect 20 can include, or can optionally be combined with the subject matter of one or any combination of Aspects 17 to 19 to optionally include locating the decoupling catch against the connector head includes: positioning the decoupling catch on an undersurface of the connector head and above the socket.

The above description includes references to the accompanying drawings, which form a part of the detailed description. The drawings show, by way of illustration, specific embodiments in which the disclosed concepts can be practiced. These embodiments are also referred to herein as “aspects” or “examples.” Such aspects or example can include elements in addition to those shown or described. However, the description also contemplates aspects or examples in which only those elements shown or described are provided. Moreover, the description also contemplates aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel,” “perpendicular,” “round,” or “square,” are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, subject matter may lie in less than all features of a particular disclosed embodiment. Thus, the following claims are hereby incorporated into the Detailed Description as aspects, examples, or embodiments, with each claim standing on its own as a separate embodiment, and it is contemplated that such embodiments can be combined with each other in various combinations or permutations. The scope of the disclosed concepts should be determined with reference to the appended claims, along with the full scope of equivalents to which such claims are entitled.

What is claimed is:

1. A disengagement lever for decoupling an electrical connector from an electrical socket, the disengagement lever comprising:
a lever housing including:
one or more walls, the one or more walls defining a cavity; and
an anchor coupled with a distal portion of the lever housing;
a lever body movably coupled with the lever housing, the lever body including:
one or more grips extending longitudinally away from the lever body; and
a decoupling catch coupled with a distal portion of the lever body, the decoupling catch including a recess; and
a biasing member operationally coupled with the lever housing and the lever body.

2. The disengagement lever of claim 1, wherein the one or more grips include a first grip positioned on a first side of the lever housing and a second grip positioned on an opposite side of the lever housing.

3. The disengagement lever of claim 1, wherein the one or more grips includes a first grip and a second grip;
wherein the lever body includes a bridge coupling the first grip with the second grip, the bridge extending through the lever housing;
wherein the bridge is configured to engage with the biasing member when a force is applied to the first grip or the second grip.

4. The disengagement lever of claim 1, wherein the lever housing includes a track formed within at least one wall of the one or more walls.

5. The disengagement lever of claim 1, wherein the one or more walls includes a first wall and a second wall opposing the first wall, each of the first wall and the second wall includes a laterally extending track;
wherein the lever body includes a bridge coupled with the one or more grips, the bridge extending through the cavity and a portion of the bridge extends into the laterally extending track of the first wall and the second wall.

6. The disengagement lever of claim 1, wherein the biasing member is configured to control movement of the lever body.

7. The disengagement lever of claim 1, wherein the anchor includes:
a footing extending longitudinally away from the lever body; and
a recess formed within the footing, the recess includes an opening configured to be positioned around the electrical connector.

8. The disengagement lever of claim 1, wherein the lever housing includes a force application surface coupled to a proximal portion of the lever housing.

9. A disengagement lever to decouple an electronic connection, the disengagement lever comprising:
a lever housing including:
one or more laterally extending walls surrounding a cavity;
one or more tracks formed within at least one of the one or more laterally extending walls; and
an anchor coupled with a distal portion of the lever housing, the anchor including a footing;
a lever body translatably coupled with the lever housing, the lever body including:
one or more grips positioned external to the one or more laterally extending walls;
wherein the one or more grips are configured to receive a force; and
a decoupling catch coupled with the lever body and positioned proximate to the anchor; and
a biasing member retained within the cavity, the biasing member operationally coupled with the lever body.

10. The disengagement lever of claim 9, wherein the decoupling catch is configured to move with the one or more grips.

11. The disengagement lever of claim 9, wherein the one or more grips includes a first grip and a second grip, the lever body including a bridge coupling the first grip and the second grip;
wherein the bridge is translatably positioned within the one or more tracks.

12. The disengagement lever of claim 11, wherein a proximal portion of the biasing member is coupled with a distal surface of the cavity and a distal portion of the biasing member is coupled with the bridge.

13. The disengagement lever of claim 9, wherein each of the one or more grips extend transversely relative to the lever housing.

14. The disengagement lever of claim 9, wherein the decoupling catch includes a catch recess configured to receive a portion of an electrical connector.

15. The disengagement lever of claim 9, including a relaxed configuration and an engaged configuration;
wherein in the relaxed configuration, the biasing member statically holds the decoupling catch proximate to the anchor and in the engaged configuration the biasing member is compressed and the decoupling catch is configured to be translated away from the anchor.

16. The disengagement lever of claim 9 wherein the lever is translatably coupled along at least one of the one or more laterally extending walls of the lever housing.

17. A method for disengaging an electrical connector from an electronics board, the method comprising:
positioning a disengagement lever proximate to the electrical connector;
wherein the electrical connector includes a connector head providing electrical communication between an electrical cable and an electrical socket;
wherein the disengagement lever includes a lever housing and a lever body translatably coupled to the lever housing, the lever body including one or more longitudinally extending grips;
aligning an anchor coupled to a distal portion of the lever housing proximate to a base of the electrical socket;
wherein the anchor longitudinally extends from the lever body;
locating a decoupling catch coupled with the lever body against a portion of the connector head;
wherein the decoupling catch is positioned more proximal along the disengagement lever than the anchor, the decoupling catch longitudinally extending from the lever body;
retaining the connector head within the decoupling catch;
bracing the anchor against the base of the electrical socket proximate to the electronics board;
while bracing the anchor, applying a force to the one or more longitudinally extending grips and translating the decoupling catch away from the anchor; and
releasing the connector head from the electrical socket when translating the decoupling catch away from the anchor.

18. The method for disengaging the electrical connector of claim 17, including:
applying a force includes applying a releasing force to one or more grips extending from the disengagement lever to activate translating the decoupling catch includes.

19. The method for disengaging the electrical connector of claim 18, including:
applying a bracing force to the disengagement lever to maintain a static position of the anchor against the electronics board, the bracing force opposite to the releasing force applied to the one or more grips.

20. The method for disengaging the electrical connector of claim 17, wherein locating the decoupling catch against the connector head includes:
positioning the decoupling catch on an undersurface of the connector head and above the electrical socket.
